(19) United States
(12) Patent Application Publication
(10) Pub. No.: US 2004/0116301 A1
(43) Pub. Date: Jun. 17, 2004

(54) Superconducting borides and wires made thereof

(76) Inventors: Jeffery Tallon, Wellington (NZ); Nicholas Strickland, Lower Hutt (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/469,418

(22) PCT Filed: Feb. 28, 2002
(86) PCT No.: PCT/NZ02/00024

(30) Foreign Application Priority Data
Feb. 28, 2001 (NZ) 510263
Mar. 8, 2001 (NZ) 510409

(51) Int. Cl. H01B 1/00

(52) U.S. Cl. 505/100; 505/125

(57) ABSTRACT

The invention comprises superconducting materials comprising metal borides of chemical formula Mg₁₋ₓXₓB₂, where 0<x≦0.5 and X is Ca, Be, Al, Li, Zn, Cu, Ni, Cr, Ti, Zr, Gd or any combination thereof, which exhibit superconductivity at temperatures exceeding 30K. The invention includes superconducting wires made from Mg₁₋ₓXₓB₂ where 0≦x≦0.5 which may be made using the “powder-in-tube” method whereby precursor powders for Mg₁₋ₓXₓB₂ are inserted into a metallic tube, which may then be subjected to a series of mechanical and thermal treatments to densify and react the boride superconductor and thereby provide superconducting wire. The boride precursor may be separated from the metal of the tube using an inert spacer material such as boron nitride. Such wires may be rebundled one or more times to provide a multifilamentary superconducting wire.

### FIELD OF TIE INVENTION

The invention relates to Mg₁₋ₓXₓB₂, superconductors, and methods of forming conductors in which the superconductive material is of this compound or composition.

### BACKGROUND

Superconductors are known to have application in magnets, cables, motors, generators, transformers and other related devices and technologies. Once cooled below their critical temperature, T_{c}, superconductors lose their resistance to DC electrical current and hence conduct electricity efficiently and may carry a very high electrical current density. These remarkable properties motivate the aforementioned commercial and scientific applications. Examples of such superconductors which have been used in such applications include niobium tin and niobium titanium. These have low T_{c} values and are generally referred to as low-temperature superconductors (LTS). The discovery of high-temperature superconductor (HTS) materials based on cuprate oxides with T_{c} values exceeding the boiling point of liquid nitrogen (77K) raised the prospect of wider scale application because of their potential use at more easily accessible temperatures.

The common method for preparing long-length HTS wires is the so-called powder-in-tube method whereby precursor powders are packed into a metal tube, usually silver, which is then drawn down in size, then several of these drawn wires may be bundled together in another metal tube, usually silver, which is then subjected to a series of rolling and heat treatment steps. This results in a thin HTS tape with multiple filaments. The drawn wire may be rebundled more than once to achieve higher numbers of filaments. Filamentary wires are particularly useful for AC applications because of the need to reduce AC losses which are known to be diminished through the division of a superconductor into filaments. However, of all the known HTS cuprates only two, generally referred to as Bi₂Sr₂CaCu₂O_{8+δ} and Bi₂Sr₂Ca₂Cu₃O_{10+δ}, are amenable to the powder-in-tube tech The obstacle is that polycrystalline HTS materials must (1) be aligned so that their grains have a common c-axis alignment and (2) be densified so that grain boundaries are atomically smooth. The aforementioned bismuth based HTS cuprates have a micaceous morphology that causes their grains to be aligned in the process of the deformation of the containing metal tube. The grains also have an operative slip system that allows them to densify and achieve atomically-smooth grain boundaries. This is essential because the HTS cuprates have a very short coherence length, often less than 1.8 nm, which results in weak links between grains that have grain boundary disorder extending over a distance comparable to 1.8 nm. As noted no other HTS cuprate possess this ability under deformation to density, align and develop smooth grain boundaries. However, these HTS bismuth cuprates happen to have very weak pinning such that they cannot sustain large critical currents in the presence of a magnetic field. As a consequence HTS cuprates are in general very limited in their application in the form of superconducting wires and tapes.

### SUMMARY OF THE INVENTION

The present invention provides for superconducting materials which have a long coherence length and therefore minimise the limitations discussed above relating to weak links between grains.

In one aspect the invention comprises a superconductor which exhibits superconductivity at a temperature exceeding 30K, of chemical formula or composition Mg₁₋ₓXₓB₂, where 0<x≦0.5 and X is Ca, Be, Al, Li, Zn, Cu, Ni Cr, Ti, Zr, Gd, W, Mo or any combination thereof.

In another aspect the invention comprises an elongate superconductive electrical conductor comprising a superconductor of chemical formula or composition Mg₁₋ₓXₓB₂, where 0≦x≦0.5 and X is Ca, Be, Al, Li Zn, Cu, Ni Cr, Ti, Zr, Gd, W, Mo, or any combination thereof.

Preferably 0<x≦0.3. More preferably 0<x<0.1. Most preferably 0<x<0.08.

Preferably X is Al, Cu, Zn or a combination thereof.

In a further aspect the invention comprises a method of forming an electrical conductor including compacting within an elongate metal container particles of a superconductor of chemical formula or composition Mg₁₋ₓXₓB₂, where 0≦x≦0.5 and X is Ca, Be, Al, Li Zn, Cu, Ni Cr, Ti, Zr, Gd, W, or Mo, or any combination thereof.

Preferably the method includes mixing together and reacting precursor materials to form a superconductor of chemical formula or composition Mg₁₋ₓXₓB₂, where 0≦x≦0.5 and X is Ca, Be, Al, Li Zn, Cu, Ni Cr, Ti, Zr, Gd, W, Mo, or any combination thereof.

Preferably the method includes intimately mixing particles of the precursor materials and compacting the precursor materials into and reacting the precursor materials in an elongate metal container.

Preferably the precursor materials include elemental boron and elemental magnesium.

Preferably the method includes heating the precursor materials to a reaction temperature sufficient to vaporize the magnesium precursor to react with the boron precursor in a gas-solid reaction.

Preferably the method includes providing an inert layer between the superconductor compound or precursor materials and the interior surface of the metal container.

Preferably the inert layer is a layer of boron nitride.

Preferably the method includes placing the precursor materials within the elongate metal container such that the boron precursor material is substantially surrounded by the magnesium precursor material.

Preferably the method includes heating to react the precursor materials to a temperature between about 400° C. and about 950° C.

Preferably the method includes intimately mixing the precursor materials as particles of average particle size less than one micron prior to heating and reacting the precursor materials.

Preferably the method includes mixing the precursor materials together so as to form an alloy of precursor metals. Preferably the method includes then heating and reacting the precursor materials at a temperature in the range about 400° C to about 750° C.

Preferably the method includes subjecting the elongate metal container containing the precursor materials or an elongate component formed of an alloy of the precursor materials to mechanical deformation to density the precursor material.

Preferably the mechanical deformation includes further elongating the metal container or alloy component to reduce the cross-sectional dimension thereof and further compact the material therein.

Preferably the method includes also heating the metal container or alloy component while subjecting it to mechanical deformation to assist in densifying the material.

Preferably the method includes carrying out a heat treatment of the superconductor to precipitate borides of the substituent metal X from the superconductor.

Preferably the method includes heating to sinter particles of the superconductor together.

The invention also includes a method of forming an electrical conductor including the steps of: intimately mixing at the sub-micron level particles of a magnesium precursor material and a boron precursor material and a precursor material which is a source of Ca, Be, AL, Li, Zn, CU, Ni, Cr, Ti, ZR, Gd, W, Mo or any combination thereof compacting the precursor materials within an elongate metal tube, subjecting the metal tube to mechanical deformation to reduce the cross-sectional dimension thereof and further compact the materials therein, and heating the metal container to react the precursor materials to form a superconductor of chemical formula or composition Mg₁₋ₓXₓB₂, where 0≦x≦0.5 and X is Ca, Be, Al, Li Zn, Cu, Ni Cr, Ti, Zr, Gd, W, or Mo, or any combination thereof, where x is between 0≦x≦0.5 and to precipitate fluxpinning-effective borides of the substituent metal X distributed within the resultant superconductor material.

The invention also includes a method of forming an electrical conductor including the steps of: intimately mixing at the sub-micron level particles of a magnesium precursor material and a boron precursor material and a precursor material which is a source of Ca, Be, AL, Li, Zn, CU, Ni, Cr, Ti, ZR, Gd, W, Mo or any combination thereof, subjecting the elongate alloy component to mechanical deformation to reduce the cross-sectional dimension thereof, and heating the alloy component to react the precursor materials to form a superconductor of chemical formula or composition Mg₁₋ₓXₓB₂, where 0≦x≦0.5 and X is Ca, Be, Al, Li Zn, Cu, Ni Cr, Ti, Zr, Gd, W, or Mo, or any combination thereof, where x is between 0≦x≦0.5 and to precipitate fluxpinning-effective borides of the substituent metal X distributed within the resultant superconductor material.

### BRIEF DESCRIPTION OF THE FIGURES

The invention is further illustrated by the following examples and is described with reference to the accompanying figures in which:

FIG. 1 is a schematic diagram of the cross-section of a conductor comprising a metal tube and precursor to the boride superconductor.

FIGS. 2A and 2B are schematic diagrams of the cross-section of flat or tape conductors comprising a metal tube and precursor to the boride superconductor.

FIG. 3 is a schematic diagram of the cross-section of an approximately circular conductor comprising a metal tube, boron or the precursor to the material Mg₁₋ₓXₓB₂ and optional metal tube comprising predominantly magnesium and an inert spacer layer which protects the metal tube from reaction with the superconductor precursor.

FIG. 4 is a schematic diagram of the cross-section of an approximately circular multifilamentary conductor comprising a metal tube, containing individual wire filaments which may be the wires or FIG. 1 or of FIG. 3 an alternative layout using flat tapes such as those shown in FIG. 2 as flat filaments could be used.

FIG. 5 is a plot of the resistivity for samples of composition Mg₁₋ₓCaₓB₂ with x=0, 0.05 and 0.10, (the last sample is multiphase).

FIG. 6 is a plot of the resistivity for samples of nominal composition Mg₁₋ₓNiₓB₂ with x=0, 0.03, 0.05 and 0.08.

FIG. 7 is a plot of the resistivity for samples of composition Mg₁₋ₓZnₓB₂ with x=0, and 0.05.

FIG. 8 is a plot of the resistivity of the face of MgB₂ material that had been reacted in a stainless steel tube at 900° C. The face of the material was adjacent to the stainless steel and shows no degradation of T_{c}.

FIG. 9 is a plot of the resistivity for samples of composition Mg₁₋ₓCuₓB₂ with x=0, 0.10 and 0.20.

FIG. 10 shows 12 x-ray diffraction traces for the cores of alloyed magnesium-boron material reacted at the temperatures and duration shows for each trace. The upper trace shows the pattern for the precursor magnesium-boron material and the bottom trace shows the pattern for a conventional ceramic pellet sample reacted at 900° C. In all cases reactions were carried out in an atmosphere of 5% H₂ and 95% argon.

FIG. 11 shows a plot of critical current density, J_{c}, as a function of applied magnetic field for an alloyed sample reacted for two hours at 600° C.

### DETAILED DESCRIPTION

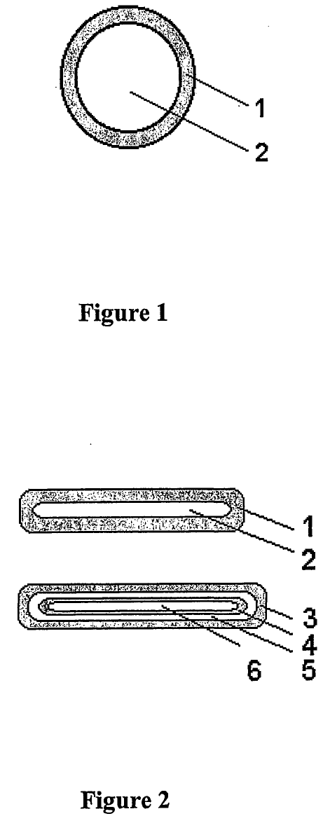

In a preferred form of the invention the precursors to the superconducting boride compositions are placed in a metal tube. The precursor materials may be in the form of elemental magnesium mixed in stoichiometric proportion with elemental boron, preferably amorphous boron, together with the substituent X in elemental form. The mixing of the precursor powders may be simple mechanical miring, as in stirring, or by milling or any other known form of mixing. We have found the reaction of the elemental precursors to be remarkably uniform in spite of poor mixing where, at the temperature of synthesis, the magnesium vaporises and reacts with the boron as a gas solid reaction. The metal tube is then preferably drawn, extruded or otherwise deformed so as to reduce its cross-sectional area to effectively densify and further compact the introduced precursor material. This simple geometry is illustrated in FIG. 1 where 1 denotes the metal tube and 2 denotes the precursor material. In general the cross-section need not be circular but may be hexagonal, square, elliptic or any other suitable shape.

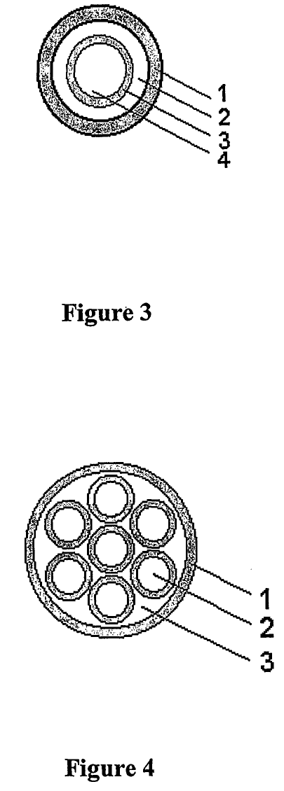

FIG. 2 illustrates another approach in which the precursor materials are placed within the encasing metal tube such that the boron precursor material is substantially surrounded by the magnesium precursor material. This approach reduces or prevents reaction of the precursor materials with the encasing metal tube 1. The material of the central core 4 may be predominantly boron. The material 3 may be predominantly magnesium or Mg₁₋ₓXₓ, preferably in the form of a metal tube. The material 2 may be an inert material such as boron nitride, for example, which has the advantage of deformability when packed in a tube which is to be drawn, extruded or subjected to other such deformations. We have found boron nitride to not react appreciably with MgB₂ or related materials under typical conditions of synthesis and reaction. Alternatively the layer 2 may be a suitable metal which protects the outer tube 1 from reaction with the Mg₁₋ₓXₓ material 3. This is especially preferred if the outer metal is copper or stainless steel, for example. The metal 2 in FIG. 3 may be nickel, aluminium, magnesium, chromium or silver and may be inserted as a tube or coated on the inner surface of the outer metal 1. Such coating techniques will be well known to practitioners of the art Aluminium is particularly preferred because it provides good electrical contact with the outer metal but if it should react with boron in the precursor material it forms AlB₂ which, while not superconducting, is a good conductive metal providing good electrical connection between the outer metal and the inner superconductor. If magnesium is used for the material 2 in FIG. 3 then layer 3 may not be necessary and material 4 may be the Mg₁₋ₓXₓB₂ precursor, with a suitable deficiency of Mg to allow for source 3 of Mg. The precursors may be elemental magnesium, elemental boron, and elemental metal x for example.

FIG. 2A is similar to FIG. 1. Outer tube 1 contains mixed precursor materials 2, or alternatively pre-reacted Mg₁₋ₓXₓB₂ material compacted into the outer tube 1. FIG. 2A is similar to FIG. 3 except that the conductor is in the form of a flat tape, comprising a metal tube 3 a boride precursor 6, a magnesium precursor 4 as a tube, and an inert layer 5 between the precursor materials and the interior of the outer tube 3.

The outer container or tube 1 in FIG. 1, FIG. 2 or FIG. 3, may be silver, gold, copper, nickel, a so-called stainless steel, or any other common metal or alloy, typically with melting point in excess of 900° C.

Following deformation of the packed metal tube, such as by extrusion, drawing, swaging or other such like deformations, then the resultant tube or wire may be bundled with other similarly produced tubes or wires, inserted in another metal tube and redeformed to produce a multicolored or multifilamentary conductor as illustrated in FIG. 4 where, for example, seven such filaments have been bundled. The choice of the number of such filaments is not restricted and such choice will be made on the basis of manufacturing convenience. The individual wires making up the multifilamentary conductor of FIG. 4 may be the wires of FIG. 1 or the heterogeneous wires of FIG. 3. The detail of the cross-sections of the individual filaments in FIG. 4 is not shown but should be understood to generally represent either a cross-sectional structure as in FIG. 1 or in FIG. 3.

Heat treatment of the aforementioned wires, tapes, or multifilamentary conductors in order to react the precursor superconductor materials involves heating at temperatures exceeding 780° C., preferably 850-950° C., for duration exceeding 10 minutes and preferably 1-4 hours, in an inert atmosphere such as nitrogen, argon, hydrogen or any combination thereof, but preferably argon and most preferably argon mixed with hydrogen. The wires, tapes or conductors may be raised quickly or slowly to the reaction temperature and may be cooled quickly or slowly back to room temperature.

Preparation of such materials, wires or tapes may be carried out in a preferred form by milling together stoichiometric quantities of Mg, X and B metals in an inert atmosphere until the precursor metals are intimately mixed at the sub-micron level eg having an average particle size less than one micron, and preferably at the nanometer level as in alloying. This intimately mixed material is found to be more reactive than mixed powders as described above. Such milling may form an alloy of the Mg, X and B metals. The intimately mixed or alloyed materials are then reacted as bulk material or introduced into a metal tube or billet so as to extrude or draw down the tube to a smaller diameter and then make a single or multiple filament wire according to methods known in the art and as described above. Such bulk material or wire then is found to react in an inert atmosphere or a reducing atmosphere such as H₂, or H₂ mixed with an inert atmosphere, for example, at a temperature between 750° C. and 850° C. for a time between 10 minutes and 6 hours. The outcome of such intimate mixing is that the reaction proceeds at a lower temperature than otherwise is achieved. In a wire or tape technology such lower temperature reaction is desirable to minimise reaction with the metal of the cladding tube and the metal matrix surrounding the filaments. The smaller is the length scale of the mixing the lower the temperature of reaction needs to be and/or the shorter the reaction time. It is preferred that the mixing be on the nanometer scale thus allowing reaction temperatures between 750° C. at 850° C., for example.

As a specific and preferred form of milling to achieve intimate nanoscale mixing, stoichiometric quantities of Mg, X and B metals may be mined in an inert atmosphere until the precursor metals are alloyed. This alloyed material is found to be very reactive and is found to be more dense than mixed and compressed powders (which may be as low as 40% of theoretical density). The alloyed materials are then reacted as bulk material or introduced into a metal tube or billet so as to extrude or draw down the tube to a smaller diameter and then make a single or multiple filament wire according to methods known in the art and as described above. Such bulk material or wire then is found to react in an inert atmosphere or a reducing atmosphere such as H₂, or H₂ mixed with an inert atmosphere, for example, at a temperature between 400° C. and 850° C. for a time between 10 minutes and 48 hours, for example. The outcome of such alloying is that the reaction proceeds at a very much lower temperature than otherwise is achieved. In a wire or tape technology such lower temperature reaction is desirable to minimise reaction with the metal of the cladding tube and the metal matrix surrounding the filaments. By such alloying reaction temperatures may be as low as 400° C., for example and such low temperatures preferably allow the use of copper metal, for example, as the cladding or matrix material. Under usual circumstances copper metal is not a suitable cladding material as it reacts with magnesium at high temperatures. This reaction is strongly enhanced above the melting point 651° C. of magnesium metal. Reducing the reaction temperature even further to below the 485° C. eutectic point of the Cu-Mg phase diagram could further reduce or eliminate alloying of Cu and Mg.

Flux pinning vortices may be introduced into in the novel materials Mg₁₋ₓXₓB₂ so as to provide for enhanced critical currents. We have observed that several substituents, X, exhibit a solid solubility up to a critical fraction, x. It is further the case that the presence of a small volume, particle, precipitate or other such inclusions of non-superconducting material causes flux lines to preferentially bind to said inclusions thus providing pinning of flux lines and consequent increase in critical current density, J_{c}. It is most desirable to increase J_{c} in superconductors. Such inclusions or precipitates may be incorporated into the structure of MgB₂ or of Mg₁₋ₓXₓB₂ by heat treatment between 400-450° C. and 950° C. so as to precipitate out the boride or borides of X. Preferred substituents, X, to provide for such precipitates include Al, Cu, Zn, Ni, Fe, Cr, Ti, Zr, Gd, W or Mo. Especially preferred substituents for causing flux pinning precipitates include Al, especially in concentrations 0.1≦Al/Mg≦0.3. Preparation of such materials with flux pinning precipitates may be carried out in preferred form by milling together Mg, X (=Al, for example) and B metals in an inert atmosphere until the precursor metals are intimately mixed at the sub-micron level and preferably at the nanometer level or alloyed. This intimately mixed or alloyed material may then be reacted as bulk material or introduced into a tube or billet so as to extrude or draw down the tube to a smaller diameter and then make a single or multiple filament wire according to methods known in the art and as described above. Such bulk material or wire may then be reacted in an inert atmosphere or a reducing atmosphere such as H₂, or H₂ mixed with an inert atmosphere, for example, at a temperature between 450° C. or 950° C. for a time between 10 minutes and 48 hours, for example, both to react to form the active superconductor but also to form the flux-pinning precipitates. In general a different heat treatment may be used to carry out the reaction and to carry out the flux-pinning precipitation. The smaller is the length scale of the mixing the lower the temperature of reaction needs to be and/or the shorter the reaction time. It is preferred that the mixing or alloying be on the nanometer scale thus allowing reaction temperatures between 750° C. and 850° C. and even as low as 400° C., for example, with the result that the precipitates (such as AlB₂, for example) do not grow to a large size, greater than 1 μm for example. It is preferred that the size of the precipitates lies between 4 and 100 nm.

### EXAMPLE 1

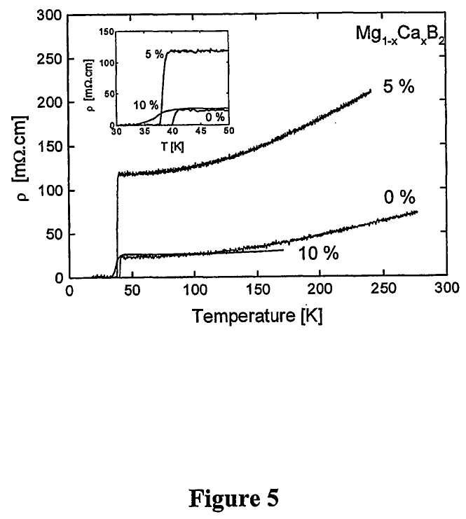

A range of calcium-substituted magnesium boride compounds of formula Mg₁₋ₓCaₓB₂ x=0, 0.05 and 0.10 were synthesised by reacting a 20 millimole stoichiometric mixture of (1-x)Mg, xCaO, xC and 2B under H₂ gas for 1 hour at 900° C. after ramping to this temperature over 1.5 hours. The presence of the carbon is necessary to carbothermally reduce the CaO. The powders were mixed, milled and die pressed into 12 mm diameter pellets. These were placed in an alumina crucible lined with tantalum metal. The pellets were capped with a sheet of tantalum then boron nitride powder was used to fill the remainder of the crucible to reduce the evolution of magnesium vapour. X-ray diffraction showed that the x=0 and x=0.05 samples were essentially single phase while other phases such as MgO and calcium boride appeared in the x=0.10 sample. The resistivity is plotted as a function of temperature in FIG. 5. This shows a superconducting transition temperature for the x=0 sample of just over 40K and a uniform reduction in T_{c} to 38.5K for the x=0.05 sample. The x=0.10 sample shows evidence in its transition of its mixed phase state.

### EXAMPLE 2

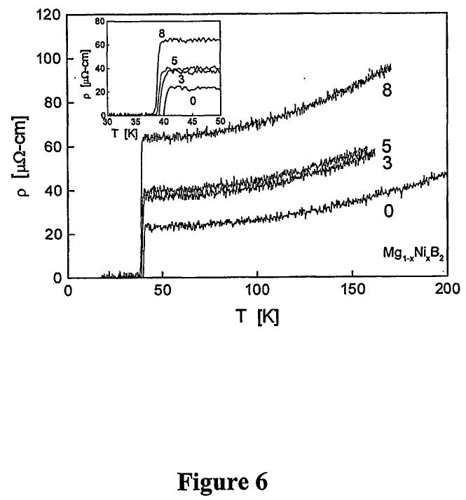

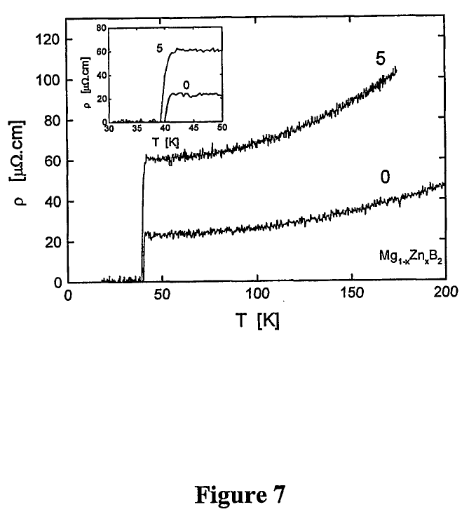

Samples of nickel- and zinc-substituted magnesium boride compounds of formula Mg₁₋ₓNiₓB₂ x=0, 0.03, 0.05 and 0.08 and Mg₁₋ₓZnₓB₂ x=0 and 0.05 were synthesised by reacting a 20 millimole stoichiometric mixture of (1-x)Mg, 2B and xNi or xZn powders under H₂ gas for 1 hour at 920° C. after ramping to this temperature over 1.5 hours. The powders were mixed, milled and die pressed into 12 mm diameter pellets. These were placed in an alumina crucible lined with tantalum metal. The pellets were capped with a sheet of tantalum then boron nitride powder was used to fill the remainder of the crucible to reduce the evolution of magnesium vapour. X-ray diffraction showed that only the MgB₂ and Mg_{1.95}Zn_{0.05}B₂ samples were single phase while other impurity phases were present in the Ni samples. The resistivity for the Ni-substituted samples is plotted as a function of temperature in FIG. 6. This shows a superconducting transition temperature for the x=0 sample of just over 40K and a uniform but very slow reduction in T_{c} to 39K for the x=0.08 sample. In spite of the presence of a small amount of impurity the resistivity remains very low and the T_{c} values hardly change. This means that magnesium boride will survive synthesis in a nickel tube and still display strong intergranular links and a relatively unchanged transition temperature. The slow reduction in transition temperature is probably associated with a small fraction of Ni substituting into the MgB₂ and acting as a magnetic pairbreaker. In contrast the effect of Zn which appears to have substituted fully into the MgB₂ structure is a very minor reduction in T_{c} consistent with the absence of a magnetic moment in the Zn atom and hence the absence of magnetic pairbreaking. This suggests that the symmetry of the order parameter is s-wave. The element Be can also be substituted into MgB₂ according to the chemical formula Mg₁₋ₓBeₓB₂ with 0≦x≦0.5 using much the same method as described above for Ni and Zn. However because of the toxicity of Be especially the oxide of beryllium it is necessary to take several precautions. Be wire is cut into short lengths and mixed with the Mg and B precursor and the mixture pressed into a pellet. The pellet is then placed on a tantalum foil and sealed in a quartz ampoule under argon gas at 0.5 atmosphere by fusing the quartz. This is then placed in a stainless steel container which is then placed in a tube furnace under a strong flow of nitrogen gas and reacted for 1 hour at 900° C. after heating to this temperature over 1.5 hours.

### EXAMPLE 3

A well mixed stoichiometric powder mixture of Mg and B was loaded into a copper tube which was then drawn down in diameter with intermittent anneals for 1 hour at 250° C. in air to eliminate the work hardening of the copper. The resultant copper-clad wire was then cut into sections and several of these were reacted for 1 hour at 900° C. under flowing hydrogen gas. The resistivity of the wire was measured and found to display a sharp superconducting transition at 40K similar to the bulk pellets described above. The surface of the MgB₂ in contact with the copper metal was then exposed. It showed some discolouration. A four terminal resistivity measurement was made on the surface exposed to the copper metal and this exhibited a very low resistivity in the normal state similar to the pure material and a good sharp transition at 40K.

### EXAMPLE 4

A well mixed stoichiometric powder mixture of Mg and B was loaded into a silver tube which was then drawn down in diameter to about 1.5 mm diameter with intermittent anneals for 1 hour at 250° C. in air to eliminate the work hardening of the silver. The resultant silver-clad wire was then cut into sections and several of these were reacted for 1 hour at 900° C. under flowing hydrogen gas. The resistivity of the wire was then measured and found to display a sharp superconducting transition at 40K similar to the bulk pellets described above.

### EXAMPLE 5

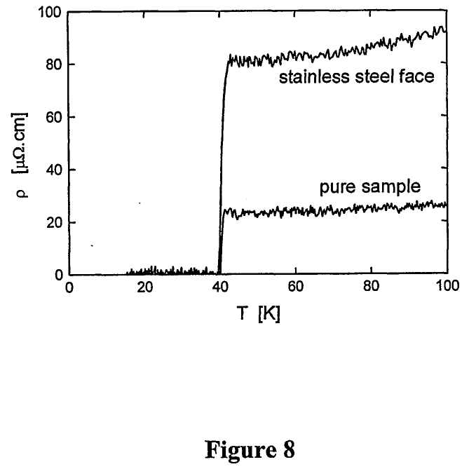

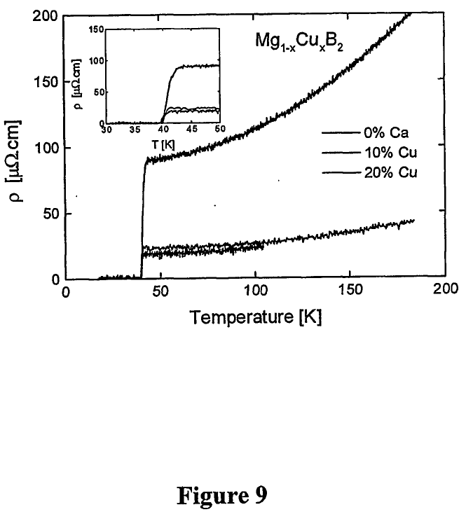

A well mixed stoichiometric powder mixture of Mg and B was loaded into a 316 stainless steel tube. This tube was then reacted for 1 hour at 900° C. under flowing hydrogen gas. The resistivity of the wire was then measured and found to display a sharp superconducting transition at 40K similar to the bulk pellets described above. A piece of 316 stainless steel foil was placed in a 12 mm die on top of a stoichiometric precurser mixture of Mg+2B. More precursor mixture was placed on top, the powder levelled and the piston inserted. A pellet was pressed with the stainless steel fully contained therein. The pellet was reacted in flowing H2 gas as above by heating to 920° C. over 1.5 hours then reacting at 920° C. for 1 hour. After cooling the pellet was then opened to expose the faces that juxtaposed the stainless steel. There was some discolouration evident. A four terminal measurement of the resistivity of the surface of the pellet adjacent to the stainless steel is shown in FIG. 8. It shows a typical low resistivity and a good sharp transition at 40K, indeed the onset of the transition is slightly higher than for the pure compound by 1.4K.

### EXAMPLE 6

Stoichiometric precursor Mg+2B powder was loaded into a copper tube lined with a thin wall of aluminium and processed as in example 4 with similar results.

### EXAMPLE 7

High purity elemental magnesium and boron were mixed in the stoichiometric proportions of MgB₂. The charge of material was then mechanically milled for 6 hours under an atmosphere of argon gas. The resultant material was packed into a copper billet which was then evacuated prior to extrusion. The billet was hot and extruded at 200° C. to form a wire. The extruded wire was then drawn down in diameter to an external hexagonal cross-section of 3.6 mm across the flats and a cylindrical internal cross-section of 2.4 mm diameter containing the densely-packed alloyed magnesium-boron material. The wire was cut into lengths of 20 to 30 mm and some had the copper cladding removed mechanically in a lathe, so that the reaction could be studied independently of the copper sheath.

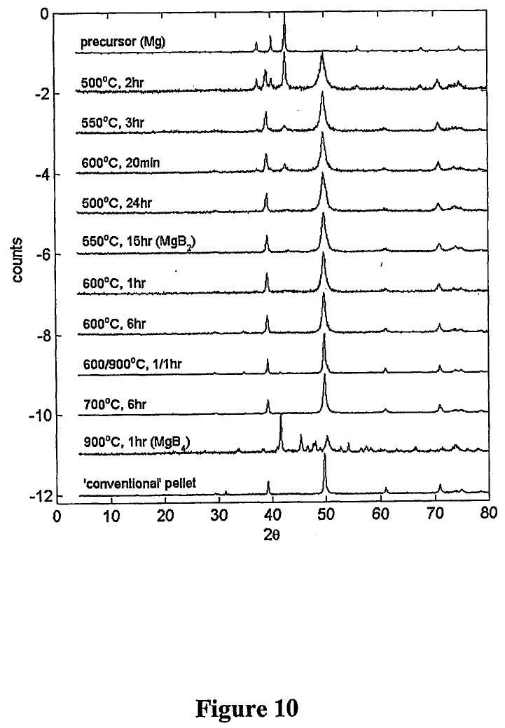

The short-length samples were reacted in an atmosphere of 5% H₂ and 95% argon for periods of time ranging from 10 minutes to 24 hours. It was generally found that when the alloyed materials were reacted under similar conditions to conventional pellets and wires as described in examples 1 to 6 above, namely around 900° C., the magnesium-boron material did not react to the desired MgB₂ phase but to MgB₄. Lower temperatures, however, resulted in successful synthesis of MgB₂. FIG. 10 summarises the results of this example in the form of x-ray diffraction patterns obtained from exposed cores of the wires after reaction. The conditions of temperature and time of reaction are listed for each diffraction trace. The diffraction pattern at the top is for the precursor magnesium-boron alloyed material while the diffraction pattern for a conventional single phase MgB₂ pellet is shown at the bottom. The second trace shows that after just two hours at 500° C. about half of the material has reacted through to MgB₂ while the fifth trace shows that after 24 hours at 500° C. the material has fully reacted to MgB₂. As a first advantage, this sample showed very little reaction with the copper cladding material. As a second advantage, the incorporation of aluminium, or some other element X, in the composition Mg₁₋ₓAlₓB₂ with concentrations 0.1≦Al/Mg≦0.3 will allow the formation of very fine precipitates of aluminium boride when reacted at temperatures as low as 500° C. Such very fine precipitates will provide for enhanced flux pinning in MgB₂.

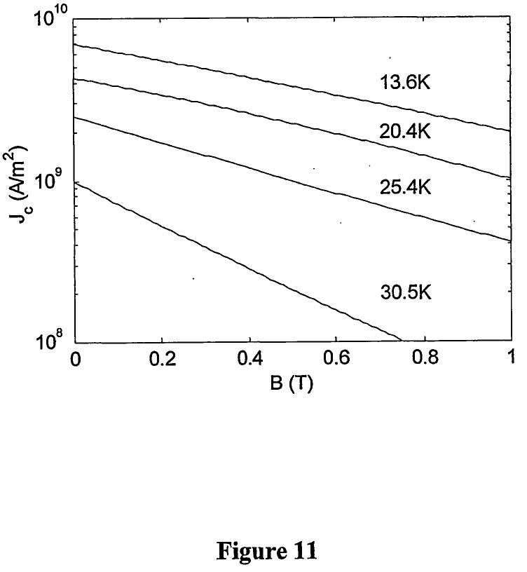

A further short-length sample was reacted in an atmosphere of 5% H₂ and 95% argon for a period of 2 hours. The sample was then investigated in a vibrating-sample magnetometer to determine the magnetisation as a function of temperature and magnetic field strength. Using the Bean critical state model and an established numerical fitting procedure the critical current density was determined from this magnetic data. FIG. 11 shows the critical current density, J_{c}, plotted as a function of applied field for various temperatures. The results indicate a J_{c} value of 7×10⁵ A/cm² at 14 K and zero applied magnetic field and 1×10⁵ A/cm² at 20 K and 1 Tesla field. These are significantly better results than those obtained for pressed, sintered pellets.

1. A superconductor which exhibits superconductivity at a temperature exceeding 30K, of chemical formula or composition Mg₁₋ₓXₓB₂, where 0<x≦0.5 and X is Ca, Be, Al, Li, Zn, Cu, Ni Cr, Ti, Zr, Gd, W, Mo or any combination thereof.

2. A compound according to claim 1 wherein 0<x≦0.3.

3. A compound according to claim 1 wherein 0<x<0.1.

4. A compound according to claim 1 wherein 0<x<0.08.

5. A compound according to any one of claims 1 to 4 wherein X is Al, Cu, Zn, or a combination thereof.

6. An elongate superconductive electrical conductor comprising a superconductor of chemical formula or composition Mg₁₋ₓXₓB₂, where 0<x<0.5 and X is Ca, Be, Al, Li Zn, Cu, Ni Cr, Ti, Zr, Gd, W, Mo, or any combination thereof.

7. A conductor according to claim 6 wherein 0<x≦0.3.

8. A conductor according to claim 6 wherein 0<x<0.1.

9. A conductor according to claim 6 wherein 0<x<0.08.

10. A conductor according to any one of claims 6 to 9 wherein X is Al, Cu, Zn or a combination thereof.

11. A conductor according to any one of claims 6 to 10 wherein the superconductor is composed of particles which have been sintered together.

12. A method of forming an electrical conductor including the steps of compacting within an elongate metal container particles of a superconductor of chemical formula or composition Mg₁₋ₓXₓB₂, where 0≦x≦0.5 and X is Ca, Be, Ai, Li Zn, Cu, Ni Cr, Ti, Zr, Gd, W, or Mo, or any combination thereof.

13. A method of forming a conductor including the steps of mixing together and reacting precursor materials to form a superconductor of chemical formula or composition Mg₁₋ₓXₓB₂, where 0≦x≦0.5 and X is Ca, Be, Al, Li Zn, Cu, Ni Cr, Ti, Zr, Gd, W, Mo, or any combination thereof.

14. A method of forming a conductor according to any one of claims 13 to 19 including intimately mixing particles of the precursor materials and compacting the precursor materials into and reacting the precursor materials in an elongate metal container.

15. A method of forming a conductor according to claim 13 or claim 14 wherein the precursor materials include elemental boron and elemental magnesium.

16. A method of forming a conductor according to claim 14 or claim 15 including heating the precursor materials to a reaction temperature sufficient to vaporize the magnesium precursor to react with the boron precursor in a gas-solid reaction.

17. A method of forming a conductor according to claim 15 including providing an inert layer between the superconductor compound or precursor materials and the interior surface of the metal container.

18. A method of forming a conductor according to claim 17 wherein the inert layer is a layer of boron nitride.

19. A method of forming a conductor according to any one of claims 14 to 18 including placing the precursor materials within the elongate metal container such that the boron precursor material is substantially surrounded by the magnesium precursor material.

20. A method of forming a conductor according to any one of claims 12 to 19 including heating to react the precursor materials to a temperature between about 400° C. and about 950° C.

21. A method of forming a conductor according to any one of claims 13 to 19 including intimately mixing the precursor materials as particles of average particle size less than one micron prior to heating and reacting the precursor materials.

22. A method of forming a conductor according to claim 21 including mixing the precursor materials together so as to form an alloy of precursor metals.

23. A method of forming a conductor according to either one of claims 21 and 22 including heating and reacting the precursor materials at a temperature in the range about 400° C. to about 750° C.

24. A method of forming a conductor according to any one of claims 21 to 23 wherein the metal container is formed from Cu, Al, or an Al alloy.

25. A method of forming a conductor according to any one of claims 12 to 24 including subjecting the elongate metal container containing the precursor materials or an elongate component formed of an alloy of the precursor materials to mechanical deformation to density the precursor material.

26. A method of forming a conductor according to claim 25 wherein the mechanical deformation includes further elongating the metal container or alloy component to reduce the cross-sectional dimension thereof and further compact the material therein.

27. A method of forming a conductor according to either one of claims 25 and 26 including heating the metal container or alloy component while subjecting it to mechanical deformation to assist in densifying the material.

28. A method of forming a conductor according to any one of claims 13 to 27 comprising the step of including particles of a fluxpinning-effective non-superconducting material in the superconductor.

29. A method of forming a conductor according to any one of claims 12 to 28 including carrying out a heat treatment of the superconductor to precipitate borides of the substituent metal X from the superconductor.

30. A method according to any one of claims 12 to 29 including heating the metal container to sinter particles of the superconductor together.

31. A method of forming an electrical conductor including the steps of:
intimately mixing at the sub-micron level particles of a magnesium precursor material and a boron precursor material and a precursor material which is a source of Ca, Be, AL, Li, Zn, CU, Ni, Cr, Ti, ZR, Gd, W, Mo or any combination thereof compacting the precursor materials within an elongate metal tube, subjecting the metal tube to mechanical deformation to reduce the cross-sectional dimension thereof and further compact the materials therein, and heating the metal container to react the precursor materials to form a superconductor of chemical formula or composition Mg₁₋ₓXₓB₂, where 0≦x≦0.5 and X is Ca, Be, Al, Li Zn, Cu, Ni Cr, Ti, Zr, Gd, W, or Mo, or any combination thereof, where x is between 0≦x≦0.5 and to precipitate fluxpinning-effective borides of the substituent metal X distributed within the resultant superconductor material.

32. A method of forming an electrical conductor including the steps of:
intimately mixing at the sub-micron level particles of a magnesium precursor material and a boron precursor material and a precursor material which is a source of Ca, Be, AL, Li, Zn, CU, Ni, Cr, Ti, ZR, Gd, W, Mo or any combination thereof, subjecting the elongate alloy component to mechanical deformation to reduce the cross-sectional dimension thereof, and heating the alloy component to react the precursor materials to form a superconductor of chemical formula or composition Mg₁₋ₓXₓB₂, where 0≦x≦0.5 and X is Ca, Be, Al, Li Zn, Cu, Ni Cr, Ti, Zr, Gd, W, or Mo, or any combination thereof, where x is between 0≦x≦0.5 and to precipitate fluxpinning-effective borides of the substituent metal X distributed within the resultant superconductor material.

33. A method according to claim 31 or claim 32 wherein X is Al, Cu, Zn or a combination thereof.

34. A method of forming a conductor according to anyone of claims 31 to 33 wherein the precursor materials include elemental boron and elemental magnesium.

35. A method of forming a conductor according to claim 31 including heating the metal container precursor materials to a reaction temperature sufficient to vaporize the magnesium precursor to react with the boron precursor in a gas-solid reaction.

36. A method of forming a conductor according to any one of claims 31 to 34 including heating the metal container or alloy component to react the precursor materials to a temperature in the range about 400° C. to about 750° C.

37. A method of forming a conductor according to claim 31 wherein the metal container is formed from Cu, Al, or an Al alloy.
